(19) United States
(12) Patent Application Publication
(10) Pub. No.: US 2014/0261339 A1
(43) Pub. Date: Sep. 18, 2014

(54) MULTI-STAGE COMPRESSORS AND ASSOCIATED SYSTEMS, PROCESSES AND METHODS

(71) Applicant: McAlister Technologies, LLC, Phoenix, AZ (US)

(72) Inventor: Roy Edward McAlister, Phoenix, AZ (US)

(21) Appl. No.: 13/802,202

(22) Filed: Mar. 13, 2013

(51) Int. Cl. F02B 33/06

(52) U.S. Cl. CPC F02B 33/06
USPC 123/562; 123/563

(57) ABSTRACT

Multi-stage compressors for compressing and/or liquefying gases are disclosed herein. A multi-stage compressor in accordance with a particular embodiment includes a cylinder bank having a plurality of cylinders. A first insert having a first inside diameter can be positioned within a first individual cylinder, and a second insert having a second inside diameter, smaller than the first inside diameter, can be positioned within a second individual cylinder. A first compression piston can be positioned within the first individual cylinder to compress the gas to a first volume and a second compression piston can be positioned within the second individual cylinder to compress the gas to a second volume, smaller than the first volume.

### TECHNICAL FIELD

The present disclosure relates generally to multi-stage compressors. More specifically, multi-stage compressors that are integral with internal combustion engines and configured to liquefy gases are disclosed herein.

### BACKGROUND

Compression and/or liquefaction of gases can provide a variety of benefits. For example, compressing natural gas into compressed natural gas increases the energy density and can allow for the storage and transportation of larger amounts of energy. Liquefying natural gas produces an even greater energy density and can similarly provide storage and transportation benefits. Additionally, the compression and liquefaction of other fuels and/or other non-fuel gases (e.g., air, nitrogen, oxygen, helium, etc.) can also provide benefits. For example, liquefied nitrogen can be used in a variety of industrial and manufacturing processes.

Various compressors have been developed to compress and/or liquefy gases. For example, shaft driven compressors, including reciprocating compressors and centrifugal compressors, are often used to compress a gas as part of a liquefaction process. Compressor driven liquefaction systems are generally powered by separate internal combustion engines or electric motors that consume large amounts of energy to drive the compressor. Additionally, liquefaction systems employing shaft driven compressors with separate power sources often occupy large operational footprints.

In view of the benefits provided by compressed and liquefied gases, and the relatively high energy consumption and large size of existing compression systems, it would be advantageous to provide a compressor that has reduced energy consumption and a smaller operational footprint.

### BRIEF DESCRIPTION OF THE DRAWINGS

Certain details are set forth in the following description and in FIGS. 1-7 to provide a thorough understanding of various embodiments of the disclosure. Other details describing well-known structures and systems often associated with compressors, internal combustion engines, heat exchangers, etc., have not been set forth in the following disclosure to avoid unnecessarily obscuring the description of the various embodiments of the disclosure.

Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is a partially schematic, overhead view of a multi-stage compressor configured in accordance with an embodiment of the present technology.

FIG. 2A is a partially schematic, cross-sectional side view of a portion of the compressor of FIG. 1.

FIG. 2B is a partially schematic, cross-sectional side view of a portion of the compressor of FIG. 1.

FIG. 3A is a partially schematic, cross-sectional view of an insert configured in accordance with an embodiment of the present technology.

FIG. 3B is an isometric view of an insert assembly configured in accordance with a further embodiment of the present technology.

FIG. 4 is a partially schematic, isometric view of a compression cylinder configured in accordance with an embodiment of the present technology.

FIG. 5 is an isometric view of the compression cylinder of FIG. 4 illustrating a swirling gas in accordance with an embodiment of the present technology.

FIG. 6 is a partial cross-sectional, side view of a compression cylinder and a compression piston configured in accordance with an embodiment of the present technology.

FIG. 7 is a partially schematic illustration of a compressor configured in accordance with another embodiment of the present technology.

### DETAILED DESCRIPTION

The present technology includes various embodiments of multi-stage compressors and systems and methods for the compression and/or liquefaction of gases. Embodiments in accordance with the present technology can include multi-stage compressors that are integral with internal combustion engines. In several embodiments, a multi-stage compressor includes a multi-cylinder internal combustion engine having two or more cylinders configured for the compression of gases, and the remaining cylinders configured to operate in a manner at least generally similar to that of a conventional internal combustion engine. For example, in one embodiment, an eight cylinder internal combustion engine can include four cylinders configured for gas compression, and four cylinders configured for conventional engine operation. In such an embodiment, the four cylinders that are configured for conventional engine operation provide power to drive pistons in the compression cylinders. In several embodiments, a cooling system is operably coupled to the multi-stage compressor to cool the gases and assist in the compression and/or liquefaction process.

FIG. 1 is a partially schematic, overhead view of a multi-stage compressor 100 configured in accordance with an embodiment of the present technology. For ease of reference, the multi-stage compressor 100 may be referred to as the compressor 100. Similarly, additional embodiments of multi-stage compressors described herein may also be generally referred to as compressors. In the illustrated embodiment, the compressor 100 includes an engine block 102 having four compression cylinders 104 (identified individually as compression cylinders 104a-104d) and four combustion cylinders 106 (identified individually as combustion cylinders 106a-106d). The engine block 102 is configured in a manner at least generally similar to a V-8 engine, and includes a first cylinder bank 108a and a second cylinder bank 108b (identified collectively as the cylinder banks 108). The compression cylinders 104 and the combustion cylinders 106 are evenly distributed between the cylinder banks 108. I.e., the first cylinder bank 108a and the second cylinder bank 108b each include two compression cylinders 104 and two combustion cylinders 106.

The compressor 100 can include a production system 109 having a variety of suitable components for the production and transport of gases, compressed gases and/or liquids. The production system 109 can include, for example, a production line 110 for transporting gas, compressed gas and/or liquids. For ease of reference, the use of the term gases and/or liquids herein can include one or more gases, compressed gases, liquids, and/or any combination of the same. In the illustrated embodiment, the production line 110 includes one or more conduits or tubes 116, and extends from an inlet 112 to an outlet 114. The tubes 116 can be operably coupled to the compression cylinders 104 and/or other components. A coolant system 117 can be operably coupled to the production system 109 via a plurality of heat exchangers 124 (identified individually as a first heat exchanger 124a through a fourth heat exchanger 124d). The coolant system 117 can include a coolant line 118 for the circulation of coolant, and can extend from an inlet 120, through the heat exchangers 124, to an outlet 122. The heat exchangers 124 can be positioned along the production line 110, such that the gas and/or liquids in the production line 110 and the coolant in the coolant line 118 flow through the heat exchangers 124 to effect a transfer of heat. The coolant system 117 can include a variety of additional suitable components. For example, the coolant system 117 can include: heat sinks, expansion valves, expansion motors, heat exchangers, flow control valves, thermostats, pumps, evaporators, condensers, etc. In some embodiments, the coolant system 117 can flow coolant in a loop, while in other embodiments, the coolant system 117 can flow coolant from a coolant source to a heat reservoir. For example, in some embodiments, the coolant system 117 can transfer heat from the production line 110 to directly heat water that flows through the coolant line 118. The heated water can be output from the coolant line 118 to a direct use (e.g., hot water for an industrial process), or can be used in an additional heat exchanger for other heating needs (e.g., a hot water heater for residential, commercial or industrial use). Additionally, other fluids (e.g., ethylene glycol, pre-cooled substances, compression heated substances, etc.) can be circulated or flowed through the coolant line 118 in one or more regions to provide cooling of the gases and/or liquids in the production line and/or to provide heating for other uses.

FIG. 2A is a partially schematic, cross-sectional side view of a portion of the compressor 100 taken along the line 2A of FIG. 1. In the illustrated embodiment, the compression cylinder 104a includes a compression piston 210a, and the combustion cylinder 106a includes a combustion piston 211. The compression piston 210a and the combustion piston 211 are operably connected to a crankshaft 202 via a crank pin 203 and connecting rods 204. Pistons in accordance with the present technology may be articulated at other crank angles by suitable throws for purposes such as smoothing operations and balancing the relative motion assembly. Similarly the V-banks may be disposed at any suitable included angle.

FIG. 2B is a partially schematic, cross-sectional side view of a portion of the compressor 100 taken along the line 2B of FIG. 1. Similar to the compression cylinder 104a and the compression piston 210a of FIG. 2A, the compression cylinders 104b-104d include corresponding compression pistons 210b-210d, respectively. The compression pistons 210a-210d (identified collectively as the compression pistons 210) are also operably coupled to the crankshaft 202 via connecting rods 204. The crankshaft 202 is driven by combustion pistons 211 positioned in the combustion cylinders 106, as shown in FIG. 2A. Inlet valves 105 can be positioned adjacent each of the compression cylinders 104 to provide for the inlet of gases to the compression cylinders 104. Similarly, outlet valves 107 can be positioned adjacent each of the compression cylinders 104 to provide for the outlet of gases and/or liquids from the compression cylinders 104. The inlet valves 105 and the outlet valves 107 can be operated via a variety of suitable pneumatic, hydraulic, mechanical, electrical and/or electromechanical devices. For example, one or more camshafts, with or without connective linkages such as rocker arms or pushrods, can be positioned to operate the inlet valves 105 and the outlet valves 107.

The compression cylinders 104b-104d include a first cylindrical insert 206a, a second cylindrical insert 206b and a third cylindrical insert 206c (identified collectively as the inserts 206) that progressively reduce an internal volume of the corresponding individual compression cylinders 104b-104d, respectively. For example, the first insert 206a can include a first inside diameter D₁ that reduces the internal volume of the compression cylinder 104b by a first amount; the second insert 206b can include a second inside diameter D₂, smaller than the first inside diameter D₁, that reduces the internal volume of the compression cylinder 104c by a second amount, greater than the first amount; and the third insert 206c can include a third inside diameter D₃, smaller than the first and second inside diameters, that reduces the internal volume of the compression cylinder 104d by a third amount, greater than the first and second amounts. Although the illustrated embodiment includes the inserts 206 in three of the four compression cylinders 104, in other embodiments more or fewer compression cylinders may include inserts. Additionally, compression cylinders in accordance with the present technology may have progressively smaller swept volumes by progressively reduced piston strokes. For example, in some embodiments, each of multiple compression cylinders and compression pistons can have the same overall dimensions, but the crankshaft and/or the connecting rods can provide for differing compression amounts.

The production line 110 can be operably coupled to a storage tank 208 to store gases and/or liquids for later use. For example, in the illustrated embodiment of FIG. 2B, the outlet 114 of the production line 110 is directly coupled to the storage tank 208. The storage tank 208 can include a variety of suitable containers, for example, composite cylinders such as those disclosed U.S. Pat. Nos. 6,446,597; 6,503,584; and 7,628,137. The storage tank 208 is schematically illustrated in FIG. 2, but it is to be understood that the storage tank 208 and/or associated systems can include a variety of suitable components, including: liners, reinforcing wraps, flow valves, pressure relief valves, controllers, etc.

Referring to FIGS. 1, 2A and 2B together, in operation, a combustible fuel (e.g., gasoline, diesel, natural gas, etc.) is ignited in the combustion cylinders 106 to drive the combustion pistons 211 and rotate the crankshaft 202. The combustion cylinders 106 and combustion pistons 211 can operate in a variety of engine cycles (e.g., two-stroke operation, four-stroke operation, etc.). Rotation of the crankshaft 202 drives the compression pistons 210 to reciprocate within the compression cylinders 104. During each rotation of the crankshaft, each of the inlet valves 105 and the outlet valves 107 can open and shut at least once in a coordinated manner to move gas (e.g., air, natural gas, propane, etc.) through the production line 110 and through each of the compression cylinders 104. More specifically, the gas can be directed into the inlet 112 of the production line 110 and through the inlet valve 105 of the first compression cylinder 104a. The rotation of the crankshaft 202 moves the compression piston 210a downward in the compression cylinder 104a admitting the gas into the compression cylinder 104a. As the crankshaft 202 continues to rotate, the inlet valve 115 of the compression cylinder 104a is closed and the compression piston 210a reverses direction, compressing the gas in a first stage of compression. As the compression piston 210a approaches top dead center, the outlet valve 107 can open, directing the pressurized gas into the production line 110 and toward the compression cylinder 104b.

In a manner at least generally similar to the compression cylinder 104a, each of the compression cylinders 104b-104d can further compress the gas in a second through a fourth stage of compression. At each corresponding stage of compression, the decreased volume produced by the inserts in the compression cylinders 104b-104d produces an increase in pressure. For example, the second compression piston 210b compresses the gas to a first volume and the third compression piston 210c compresses the gas to a second volume, smaller than the first volume.

The heat exchangers 124 can cool the gases and/or liquids as they are transported through the production line 110. In the illustrated embodiments of FIGS. 1 and 2B, there is a corresponding heat exchanger 124 that follows each stage of compression. In other embodiments, additional or fewer heat exchangers 124 may be employed. Additionally, in the illustrated embodiment, coolant flows through the heat exchangers 124 in a direction that is opposite to the flow of the gases and/or liquids. That is, the coolant passes through the fourth heat exchanger 124d first, and passes through the first heat exchanger 124a last. In other embodiments, the coolant can flow through the heat exchangers 124 in the same direction as that of the gases and/or liquids. Regardless of the direction of coolant flow, the combination of the temperature of the provided coolant and the pressure generated by the multistage compression can compress and/or liquefy gases that are transported through the production line 110.

The compressor 100 can compress a variety of suitable gases to produce compressed gas and or liquids. For example, in some embodiments, the compressor 100 can compress natural gas to produce compressed natural gas. Natural gas is piped directly to the homes of many consumers. Accordingly, a relatively low cost and efficient compressor to pressurize natural gas can provide a viable fueling option for consumers that own or operate vehicles powered by compressed natural gas. Similarly, commercial vehicle fleets that include trucks powered by compressed natural gas can also benefit from this technology. The compressor 100 can also compress and/or liquefy a variety of other gases, including air, hydrogen, propane, nitrogen, oxygen, helium, waste gases, etc. Additionally, compressors in accordance with the present technology can be configured to liquefy gases in manners described in U.S. patent application Ser. No. 13/797,869, entitled “LIQUEFACTION SYSTEMS AND ASSOCIATED PROCESSES AND METHODS,” and filed Mar. 12, 2013, which is incorporated by reference herein in its entirety.

Compressors in accordance with the present technology can be configured in a variety of suitable manners. In some embodiments compressors can be constructed from existing engines that have been modified to include operations as a compressor. In other embodiments, compressors can be constructed without the use of an existing engine. Furthermore, in several embodiments, the compression cylinders can be of different internal volumes, with or without corresponding inserts. Additionally, compressors in accordance with the present technology can provide compressed or liquefied gases for a variety of uses. In several embodiments, the compressor 100 can provide compressed gas and/or liquids to power air tools. For example, compressed gas and/or liquids from the compressor 100 or the tank 208 can be directed to a compressed gas supply line. Valves, regulators, expansion tanks, and/or other components can be included to convert liquids to gases and/or to deliver compressed gases at a desired pressure for the particular tool. In some embodiments, compressed nitrogen can be used to power air tools.

FIG. 3A is a partially schematic cross-sectional view of an insert 300 configured in accordance with an embodiment of the present technology. The insert 300 can be at least generally similar to the inserts 206 of FIG. 2 and can be configured to be positioned within the compression cylinders 104 of the compressor 100. In the illustrated embodiment, the insert 300 includes an inner annular cylinder 302 and an outer annular cylinder 304. The inner annular cylinder 302 can be thermally conductive and positioned to transmit heat to other components of the compressor 100. For example, the inner annular cylinder 302 can be a thermally conductive metal or metal alloy that can be positioned to transmit heat away from the compression cylinder 104 via suitable methods such as contact with a suitably cooled cylinder head. The inner annular cylinder 302 can also include additional and/or alternative cooling features. In the illustrated embodiment, the inner annular cylinder 302 includes a coolant channel 306 that extends from an inlet 308 through a suitable coolant circulation system such as a plurality of passageways such as one or more helical coils 310 to an outlet 312. The coolant channel 306 can be independent of or integral with the coolant system 117. For example, in one embodiment, the coolant channel 306 can be operably coupled to the coolant line 118. Coolant flowing through the coolant channel 306 can remove heat from the inner annular cylinder 302, cooling the compression cylinders 104 and any gases and/or liquids therein, including at the time heat of compression is generated. Such immediate heat removal improves the efficiency of the compression process. Additionally, the coolant channel 306 can be integral with a thermochemical regeneration (TCR) system, such as those described in U.S. Patent Application No. 61/304,403, entitled “COUPLED THERMOCHEMICAL REACTORS AND ENGINES, AND ASSOCIATED SYSTEMS AND METHODS,” and filed Feb. 14, 2011, the entirety of which is incorporated by reference herein. In such embodiments, heat removed from the compression cylinders 104 can be used to enhance the efficiency and/or reduce the emissions of the compressor 100.

Gas compressed within the compression cylinders 104 can be mixed and/or stratified by cooling provided by the inserts 300. For example, as the inserts 300 are cooled by the circulation of coolant within the inner annular cylinders 302, the compressed gas can be circulated to stratify within the compression cylinders 104, with the cooled gas moving toward the inner portion of the associated compression cylinder 104. All real gases (except hydrogen, helium and neon) are heated by such compression and such heat is transferred during compression to compression chamber components and/or coolant in passageways surrounding the compression stroke of each compression piston.

The outer annular cylinder 304 can be insulative and positioned to prevent the transmission of heat from the compression cylinders 104 to other components of the compressor 100 (e.g., the cylinder banks 108 or the crank case). Insulating the compressor 100 from the heat generated within the compression cylinders 104 can provide multiple benefits. In some embodiments, reducing the heat transmitted to the compressor 100 can increase the heat available for utilization in related operations such as a TCR system. Additionally, reducing the heat transmitted to the compressor 100 can decrease negative effects that high temperatures can have on mechanical and/or electrical components.

FIG. 3B is an isometric view of an insert assembly 320 configured in accordance with an embodiment of the present technology. In the illustrated embodiment, the insert assembly 320 includes a first insert or insert sleeve 322a and a second insert or insert sleeve 322b (identified collectively as insert sleeves 322). The insert sleeves 322 can be at least generally similar to the inserts 300 of FIG. 3A. For example, the insert sleeves 322 can include inner annular cylinders 302 and outer annular cylinders 304. The inner annular cylinders 302 can include coolant channels 306 that extend from inlets 308 through a plurality of coils 310 to outlets 312. The insert assembly 320 can further include a plurality of bolt holes 324. In several embodiments, one or more insert assemblies 320 can be positioned within an engine to convert the engine to include operation as a compressor. For example, in one embodiment, the compressor 100 can be constructed by positioning the insert assembly 320 in the first cylinder bank 108a, with the first insert sleeve 322a within the second compression cylinder 104b and the second insert sleeve 322b within the fourth compression cylinder 104d. A second insert assembly that includes an insert sleeve appropriately sized for the second cylinder bank 108b can be installed therein. The engine heads can then be installed with bolts positioned to extend through the bolt holes 324. In several embodiments, the insert assembly 320 can function as a gasket that seals the compression and combustion cylinders of a compressor.

Swirl of fluids within a compression cylinder can be induced by a variety of methods including the fluid flow angle of tangential entry during the intake stroke and/or the use of suitable inlet port fins to induce swirl. FIG. 4 is a partially schematic, isometric view of a compression cylinder 400 configured in accordance with an embodiment of the present technology. In the illustrated embodiment, an inlet valve 402 and an outlet valve 404 can be positioned to extend at least partially through a cylinder head 406 into the compression cylinder 400. The inlet valve 402 is positioned at least partially within an inlet port 403 that opens to the compression cylinder 104 near a sidewall 407. The inlet port 403 is positioned at an angle to an axis A that extends coaxially with the compression cylinder 400. The position and angle of the inlet port 403 can produce a swirl to a gas that is injected or introduced to the compression cylinder 400, as further described below. The outlet valve 404 is positioned at least partially within an outlet port 405 that can be positioned toward the center of the compression cylinder 400 and aligned with the axis A. The compression cylinder 400 also includes a directing fin 408 positioned adjacent to or on the sidewall 407. The directing fin or fin 408 includes a coolant system having an inlet 410 and an outlet 412. The fin 408 can induce a swirl to gas that is introduced to the compression cylinder 400 and cool the gas, as further described below.

FIG. 5 is an isometric view of the compression cylinder 400 illustrating a swirling gas 502 in accordance with an embodiment of the present technology. Referring to FIGS. 4 and 5 together, the fin 408, the angle of the inlet port 403 and/or the position of the inlet port 403 can produce a swirl in injected gas as a result of the gas following the sidewall 407. In the illustrated embodiment of FIG. 5, the swirling gas 502 is rotating in a counterclockwise pattern. The counterclockwise pattern can be initiated by directing gas into the compression cylinder 400 in the direction of arrow 512, e.g., via the injection port 403 of FIG. 4. The swirling gas 502 can separate into a stratified pattern within the compression cylinder 400 based on temperature differences including via the Ranques-Hilsch effect. For example, hot gases (illustrated by arrows 508) swirl in an outer region 504, and cool gases (illustrated by arrows 510) swirl in an inner region 506. In the illustrated embodiment, the inner region 506 and the outer region 504 are separated at a boundary line 514. However, it is to be understood that the separation between the inner region 506 and the outer region 504 may not always be clearly defined. For example, the swirling gases can separate into a pattern having a continuum of temperatures from a relatively hot region close to the cylinder wall, to a relatively cool region closer to the center of the cylinder. Regardless, the separation of the gases into hot and cold regions can aid in the heat removal, and thus, compression and/or liquefaction of gases by the compressor 100, as further described below. In several embodiments, the impingement of hot fluid molecules upon cooled cylinder surfaces improves the thermal gradient and thus the rate and efficiency of cooling. Additionally, cooled molecules can be located within heat transfer layers, as further described below.

In embodiments where an outlet port (e.g., the outlet port 405) is positioned near the central axis A, the cool gases in the inner region 506 (FIG. 5) can be expelled from the compression cylinder 400 first. Accordingly, the operation of the compression cylinder 400 can preferentially expel the cooler gases. In some embodiments, the compression cylinders 104, 400 and/or the compression pistons 210 can be sized and/or configured to expel a selected portion of the gases that are contained within the compression cylinder 104, 400. For example, the selected portion can correspond to a volume that includes a larger proportion of cool gases than of hot gases. Accordingly, the compressor 100 can increase the rate at which it cools gases by selectively expelling the cooled portion of the gases.

Although the inlet port 403 of FIG. 4 is shown positioned near the sidewall 407, in other embodiments, the inlet port 403 can be positioned in a variety of suitable locations with respect to the compression cylinder 400. For example, the inlet port 403 can be positioned near the center of the compression cylinder 400, and an angle of the inlet port 403 can produce a swirl in an injected gas. Similarly, the outlet port 405 can be positioned in a variety of suitable locations, including positions near the axis A.

Embodiments in accordance with the present technology can induce a swirl in gases via a variety of suitable manners. For example, in addition to the angled inlet port 403, one or more directing fins (e.g., the directing fin 408) can induce a swirl. As illustrated in FIG. 4, the directing fin 408 can be positioned on the sidewall of the compression cylinder 400 near the inlet port 403. Gases injected into the compression cylinder 400 can impact the directing fin 408 and be directed into a swirling pattern via the shape of the directing fin 408. Additionally, although the injecting port 403 is positioned at an angle to induce a swirl, the directing features such as the fin 408 can induce a swirl to gases that are injected or introduced to the compression cylinder 400 via injection ports that are coaxial with the axis A. Accordingly, the directing fin 408 can both 1) induce a swirl in a gas; and 2) increase an existing swirl in a gas. Additionally, the directing fin 408 can cool gases as they are introduced into the compression cylinder 400. Coolant can be directed to the inlet port 410, through a coolant line that is internal to the directing fin 408, and out the outlet port 412. Accordingly, the surface of the directing fin 408 can be cooled, thereby cooling the gases that are introduced into the compression cylinder 400.

Although the fin 408 of the illustrated embodiment is positioned to extend around only a portion of the compression cylinder 400, directing fins in accordance with the present technology can precede the inlet valve and/or extend around a greater or smaller portion of the compression cylinder 400. In several embodiments, a directing fin can encircle the internal circumference of the compression cylinder 400. Furthermore, multiple directing fins 408 can be utilized, including operation in positions before one or more inlet valves and/or within one or more compression cylinders 400 of a compressor.

In several embodiments, one or more inlet valves 402 can induce swirl in gases that are introduced to a compression cylinder. For example, the inlet valves 402 can be asymmetrical or have grooves, striations or other features that interact with gases traveling through the inlet port 410 to produce swirl.

FIG. 6 is a partial cross-sectional, side view of a compression cylinder 602 and a compression piston 604 configured in accordance with an embodiment of the present technology. In the illustrated embodiment, the compression cylinder 602 includes a striated cylinder head 606 having a plurality of grooves or striations 612 and a plurality of outlet ports 608. The compression piston 604 includes a similarly striated piston head 610 having a plurality of grooves or striations 614. The striations 612 on the cylinder head 606 and the striations 614 on the piston head 610 are arranged in a swirl pattern that can induce swirling in injected gases. For example, as a gas is injected into the compression cylinder 602, the gas can impact the striations 612 and 614 and be directed in the direction of the striations 612 and 614. Similarly, as the compression piston 604 moves upwardly within the compression cylinder 602, the striations of the piston head 610 can impact the gases, causing further swirl. Additionally, as the gases are forced upwards in the compression cylinder 602, the gases can again impact the striations 612 of the cylinder head 606, resulting in even further swirling. Accordingly, the striations 612 and 614 of the illustrated embodiment can produce significant swirling of gases within the compression cylinder 602, resulting in a temperature separation of the gases including via the Ranques-Hilsch effect.

The plurality of outlet ports 608 can aid in the separation of liquids and gases. As shown in FIG. 6, the outlet ports 608 can be aligned within the striations of the cylinder head 606. Channels for transporting gases and/or liquids can extend from the outlet ports 608 to the production line 110, the storage tank 208 (FIG. 2B) and/or other collection systems. In some embodiments, the outlet ports 608 that are located lower in the cylinder head 606 (i.e., toward the compression piston 604) can lead to channels that transport liquids, and the outlet ports 608 that are located higher in the cylinder can lead to channels that transport gases. As the compression piston 604 reciprocates within the compression cylinder 602, forming compressed gases and liquids, the denser vapors or liquids occupy the lower portion of the available internal cylinder volume. As the compression piston 604 moves upwards, the lower outlet ports 608 can direct the vapors or liquids towards a liquid collection system, and the upper outlet ports 608 can direct the compressed gases toward an additional compression cylinder 602 and/or toward a compressed gas collection system. Accordingly, the compression cylinder 602 and the compression piston 604 can separate compressed gases, vapors, and liquids.

The compression of gases having multiple constituents (e.g., air) can result in a cascading liquefaction of the constituents. For example, as a result of the varying temperatures and pressures of liquefaction for each constituent, liquefaction can occur within different compression cylinders for different constituents. Compressors in accordance with the present technology can include one or more striated compression cylinders 602 and compression pistons 604 that can sequentially collect the liquefied constituents at different stages within a compressor.

In several embodiments, compressors in accordance with the present technology can be used to separate gases at a mixed gas source. For example, the sequential collection of gas, vapor or liquid constituents within the compressor 100 can allow the separation of waste gases at industrial production or mining sites. In one embodiment, the compressor 100 can separate hydrogen sulfide from a natural gas source (e.g., coal bed methane). Similarly, the compressor 100 can also separate carbon dioxide and/or water vapor from coal bed methane.

FIG. 7 is a partially schematic illustration of a compressor 700 configured in accordance with an embodiment of the present technology. The compressor 700 can include features at least generally similar to the compressor 100 of FIG. 1. For example, in the illustrated embodiment, the compressor 700 includes an engine block 702, a production system 709, a coolant system 717, and a controller 711. The coolant system 717 includes a coolant line 718 that extends through a heat exchanger 724. The production system 709 can extend through a production line 710 that also extends through the heat exchanger 724. One or more sensors 725 and valves 727 can be positioned within the production system 709 and/or the coolant system 717. The controller 711 can be electrically coupled to the valves 727 and the sensors 725 and can include a processor 734, memory 736, electronic circuitry, and electronic components for controlling and/or operating the compressor 700. For example, computer readable instructions contained in the memory 736 can include operating parameters and instructions that can control the operation of the compressor 700. The sensors 725 can include temperature sensors, pressure sensors, flow meters, and/or other electrical, mechanical or electromechanical devices that can measure operating parameters of the compressor 700. In operation, the controller 711 can receive inputs from the sensors 725 and control operation of the valves 727 and/or other compressor components or operations (e.g., ignition timing, valve timing, etc.). In several embodiments, the operation of the sensors 725 and/or the valves 727 can control the release of liquids from one or more compression cylinders of the compressor 700.

In some embodiments, the valves 727 in the production system 709 can operate to direct compressed gases through the compressor 700 to provide additional compression. For example, the valves 727 can include three-way valves that can direct compressed gases exiting the compressor toward a storage system or toward a conduit or tube that leads back to a compression cylinder. In this manner, the compressor 700 can adjust the level of compression and/or liquefaction, and can run gases through the compression cylinders multiple times. Coolant system 717 can provide circulation of coolant in some zones of operation that have been previously compressed and cooled to enable operations such as compression and liquefaction of gases such as hydrogen, helium and neon. Illustratively a mixture of methane, carbon monoxide and hydrogen can be separated into methane and carbon monoxide that are utilized to cool hydrogen sufficiently regarding the inversion temperature to enable production of liquid hydrogen.

Although several components of FIG. 7 are shown adjacent to the engine block 702 for ease of illustration, it is to be understood that these components can also be attached to or integrated with the engine block 702. For example, in several embodiments, the valves 727 and sensors 725 can be positioned within the engine block 702 or coupled thereto.

Compressors in accordance with the present technology can operate in a variety of suitable manners to combust fuels and/or compress gases. In several embodiments, the compressors 100 and 700 can be configured to combust a fuel in the combustion cylinders and compress the same fuel in the compression cylinders. For example, the compressors 100 and 700 can combust natural gas in one or more combustion cylinders, and compress natural gas in one or more compression cylinders. The compressed natural gas can be directed to a collection tank (e.g., the storage tank 208) and/or to one or more combustion cylinders. In several embodiments, natural gas from the storage tank 208 can be directed to the compressors 100 or 700. In other embodiments, the compressors 100 and 700 can similarly compress and combust other fuels (e.g., propane, hydrogen, etc.)

Compressors in accordance with the present technology can be particularly effective when utilized with hydrogen. For example, hydrogen has a negative Joule-Thomson coefficient at temperatures above 200 K. Accordingly, when hydrogen is compressed at temperatures above 200 K, it cools. The cooling effects provided by the embodiments described above, in combination with the inherent cooling provided by the compression of hydrogen, can result in a more rapid cooling.

Furthermore, hydrogen fuels can increase the efficiency of engines in a variety of manners. For example, the addition of hydrogen to another fuel (e.g., diesel) that is combusted in an internal combustion engine can provide for increased peak pressure, as described in U.S. patent application entitled “JOULE-THOMPSON COOLING AND HEATING OF COMBUSTION CHAMBER EVENTS,” Attorney Docket No. 69545.8340US00, and filed on or before Mar. 15, 2013, is incorporated by reference herein in its entirety. As described above, several embodiments in accordance with the present technology can be used to produce compressed and/or liquid hydrogen. Accordingly, the operation of compressors in accordance with the present technology to produce compressed or liquid hydrogen can assist in increasing engine and/or compressor efficiency. Additionally, in several embodiments, compressors can produce compressed or liquid hydrogen that can be combusted in the combustion cylinders of the same compressor. For example, the compressor 100 can produce compressed and/or liquid hydrogen in the compression cylinders 104 that is combusted in the combustion cylinders 106.

From the foregoing, it will be appreciated that specific embodiments of the invention have been described herein for purposes of illustration, but that various modifications may be made without deviating from the spirit and scope of the various embodiments of the invention. For example, several embodiments may include various suitable combinations of components, devices and/or systems from any of the embodiments described herein. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

I/We claim:

1. A multi-stage compressor comprising:
an engine block having a plurality of compression cylinders and a plurality of combustion cylinders;
a plurality of compression pistons, individual compression pistons operably positioned at least partially within corresponding compression cylinders;
a plurality of combustion pistons, individual combustion pistons operably positioned at least partially within corresponding combustion cylinders;
a crankshaft operably coupled to the compression pistons and the combustion pistons, wherein the combustion pistons are operable to rotate the crankshaft and drive the compression pistons to compress gases;
a production line operably coupled to the compression cylinders and configured to transport the compressed gases; and
a plurality of heat exchangers operably coupled to the production line to cool the compressed gases.

2. The multi-stage compressor of claim 1, further comprising a plurality of inlet ports, individual inlet ports positioned to direct the gases toward sidewalls of corresponding individual compression cylinders.

3. The multi-stage compressor of claim 2, further comprising a plurality of outlet ports, individual outlet ports positioned to direct gases from corresponding compression pistons to the production line, wherein the individual outlet ports are positioned to receive a cooled portion of a stratified gas mixture.

4. The multi-stage compressor of claim 1, further comprising a plurality of inserts, individual inserts corresponding to individual compression cylinders, and wherein the plurality of inserts progressively decrease the internal volume of the compression cylinders.

5. The multi-stage compressor of claim 1, further comprising a plurality of inserts, wherein individual inserts are positioned within corresponding individual compression cylinders, and wherein individual inserts include coolant channels configured to circulate a coolant and cool the compressed gases.

6. The multi-stage compressor of claim 1, further comprising a cooling line extending through the plurality of heat exchangers, wherein individual heat exchangers are positioned to receive gases from corresponding individual compression cylinders, and wherein the cooling line directs coolant to a first individual heat exchanger corresponding to a last compression stage before directing the coolant to a second individual heat exchanger corresponding to a first compression stage.

7. The multi-stage compressor of claim 1, further comprising a storage tank, wherein the production line is operably coupled to the storage tank and configured to transport liquids to the storage tank.

8. A multi-stage compressor for compressing gases, the multi-stage compressor comprising:
an engine block having a plurality of compression cylinders and a plurality of combustion cylinders;
a plurality of compression pistons, individual compression pistons operably positioned at least partially within corresponding compression cylinders;
a plurality of combustion pistons, individual combustion pistons operably positioned at least partially within corresponding combustion cylinders;
a crankshaft operably coupled to the compression pistons and the combustion pistons, wherein the combustion pistons are operable to rotate the crankshaft and drive the compression pistons; and
a plurality of inlet ports, individual inlet ports positioned to deliver gases to corresponding compression cylinders, wherein the individual inlet ports are disposed at an angle to their corresponding compression cylinder, and wherein the angle is selected to produce a swirl to gases that are delivered to the compression cylinders via the inlet ports.

9. The multi-stage compressor of claim 8, further comprising a production line and a storage tank, wherein the production line is operably coupled to the compression cylinders and to the storage tank, and wherein the production line is further configured to transport liquids to the storage tank.

10. The multi-stage compressor of claim 9 wherein individual compression cylinders include corresponding sidewalls, the multi-stage compressor further comprising a fin positioned adjacent to an individual sidewall, wherein the fin is positioned to induce a swirl to gases introduced into the corresponding individual compression cylinder.

11. A multi-stage compressor for compressing a gas, the multi-stage compressor comprising:
a cylinder bank having a plurality of cylinders;
a first insert positioned in a first individual cylinder and having a first inside diameter;
a second insert positioned in a second individual cylinder and having a second inside diameter, smaller than the first inside diameter;
a first compression piston positioned within the first individual cylinder; and
a second compression piston positioned within the second individual cylinder, wherein the first compression piston compresses the gas to a first volume, and the second compression piston compresses the gas to a second volume, smaller than the first volume.

12. The multi-stage compressor of claim 11, further comprising an input port positioned to direct the gas into the first individual cylinder, wherein the input port is positioned at an angle relative to a vertical axis extending through the first individual cylinder, and wherein the angle of the input port directs the gas toward a sidewall of the first individual cylinder to induce a swirl in the gas.

13. The multi-stage compressor of claim 11, further comprising a fin positioned adjacent to a sidewall of the first individual cylinder, wherein the fin is positioned to induce a swirl to gases introduced into the first individual cylinder.

14. The multi-stage compressor of claim 11 wherein the first insert and the second insert include corresponding coolant channels, and wherein the coolant channels are configured to circulate coolant to cool the gas.

15. A method for compressing gases, the method comprising:
combusting fuel in a plurality of combustion cylinders to reciprocate pistons and rotate a crankshaft;
driving compression pistons positioned within corresponding compression cylinders via the crankshaft to compress gases; and
transporting the gases through a plurality of heat exchangers via a production line.

16. The method of claim 15, further comprising circulating coolant through inserts positioned within the compression cylinders to cool the gases.

17. The method of claim 15, further comprising operating a valve to direct compressed gases through the compression cylinders to further compress the gases.

18. A method for compressing gases, the method comprising:
injecting gases into a compression chamber;
inducing a swirl to the gases; and
compressing the gases with a compression piston.

19. The method of claim 18 wherein inducing a swirl to the gases includes directing the gases into the compression chamber at an angle to impact a sidewall of the compression chamber.

20. The method of claim 18 wherein inducing a swirl to the gases includes directing the gases into a swirl via a fin positioned adjacent to a sidewall of the compression chamber.

21. A multi-stage compressor for compressing a gas, the multi-stage compressor comprising:
a plurality of cylinders;
a crankshaft with a plurality of throw magnitudes to articulate a plurality of pistons;
a first compression piston attached to the crankshaft and positioned to reciprocate within a first compression cylinder; and
a second compression piston attached to the crankshaft and positioned to reciprocate within a second compression cylinder, wherein the second compression piston is reciprocated a smaller magnitude by the crankshaft than the magnitude reciprocated by the first piston, and wherein the first compression piston compresses the gas to a first volume, and the second compression piston compresses the gas to a second volume, smaller than the first volume.
